(19) United States
(12) Patent Application Publication
(10) Pub. No.: US 2005/0147837 A1
(43) Pub. Date: Jul. 7, 2005

(54) Fabrication method for polarizing plate, polarizing plate, optical film and image display

(75) Inventors: Naoki Tsujiuchi, Osaka (JP); Akihiro Nishida, Osaka (JP); Kenji Yoda, Osaka (JP); Yuuji Saiki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/027,988

(22) Filed: Jan. 4, 2005

(30) Foreign Application Priority Data
Jan. 6, 2004 (JP) 2004-1291
Jul. 15, 2004 (JP) 2004-208584

(51) Int. Cl. B32B 27/42

(52) U.S. Cl. 428/515; 428/501

(57) ABSTRACT

A fabrication method for a polarizing plate having a transparent protective film provided on at least one surface of a polarizer, wherein the transparent protective film provided on the at least one surface comprises a cyclic olefin-based resin as a main component, at least one resin layer and a polyvinyl alcohol-based adhesive layer are sequentially laminated on a surface of the transparent protective film that is adhered to the polarizer and comprising a step of: adhering the polyvinyl alcohol-based adhesive layer on the transparent protective film and the polarizer in a condition of an aqueous liquid is present on an adhesion surface between the polyvinyl alcohol-based adhesive layer on the transparent protective film and the polarizer. The polarizing plate obtained is a good in adhesive strength and has a uniform polarization characteristic.

### BACKGROUND OF THE INVENTION

1. Field of the Invention

This invention relates to a fabrication method for a polarizing plate. The invention further relates to a polarizing plate obtained with the fabrication method. The polarizing plate alone or as an optical film formed by laminating the polarizing plate can constitute an image display such as a flat panel display, for example a liquid crystal display (hereinafter abbreviated as LCD), an electroluminescence display (hereinafter abbreviated as ELD), or a plasma display panel (hereinafter abbreviated as PDP).

2. Description of the Background Art

Conventionally, as a polarizing plate used in LCD, there has been generally employed a polarizing plate obtained by adhering transparent protective films to both surfaces of a polarizer with an adhesive. Generally, the polarizer is of a polyvinyl alcohol type fabricated by dying iodine or a dichroic dye to be adsorbed to polyvinyl alcohol and stretching the polyvinyl alcohol so as to be aligned and triacetyl cellulose is used as the transparent protective films.

Triacetyl cellulose is, however, not sufficient in moisture and heat resistance. Hence, a polarizing plate using triacetyl cellulose films as transparent protective films has a fault of lowering its polarization performance: to be detailed, degrading its degree of polarization and hue if being used under high temperature and high humidity. Besides, a triacetyl cellulose film has a large retardation in an oblique direction. The use of a triacetyl cellulose film as a transparent protective film, therefore, has increased an adverse influence on a viewing angle characteristic of LCD in progress toward a large scale thereof in recent years.

In order to solve the above problem, it has been proposed to employ a cyclic olefin-based resin as a material of a transparent protective film instead of triacetyl cellulose. A cyclic olefin-based resin is low in moisture permeability and has almost no retardation in an oblique direction. The use of a polyvinyl alcohol-based adhesive, which has been conventionally employed in adhesion of a triacetyl cellulose film to a polyvinyl alcohol type polarizer, causes a poor adherence between a cyclic olefin-based resin and a polyvinyl alcohol type polarizer.

Therefore, a method has been proposed in which a transparent protective film made of a cyclic olefin-based resin is adhered to a polyvinyl alcohol type polarizer with, for example, an acrylic-based pressure sensitive adhesive layer interposed therebetween (JP-A No. 5-212828). This method, however, requires heat pressure bonding and a long time for heating; therefore, it has had a problem that the polyvinyl alcohol polarizer is discolored and greatly lowers its degree of polarization. Besides, since the method requires heating for a long time, a problem has arisen that fabrication efficiency is reduced and that the film is deformed.

Another method has been proposed in which a transparent protective film obtained by laminating a polyurethane resin layer and a polyvinyl alcohol layer on a thermoplastic saturated norbornene-based resin film is adhered to a polyvinyl alcohol type polarizer with a polyvinyl alcohol-based adhesive to thereby fabricate a polarizing plate (JP-A No. 2001-174637). This method, however, generates a rise, a striation and the like in the course of adhesion of the transparent protective film to the polyvinyl alcohol type polarizer, having led to a problem of unstable appearance and poor productivity. Such a fault of striation appearance exerts an adverse influence on required high level characteristics of a polarizing plate, especially on optical uniformity among the characteristics. For this reason, improvement was unable to be adapted for uniformity of a screen image and a quality thereof required as well as higher definition and higher functionality of LCD. A striation appearance defect means a fault that is seen as a linear striation or striations in parallel to the absorption axis direction of a polarizing plate in a state of reflection produced in the course of adhesion of a transparent protective film to a polarizer. A feature of a striation or striations is being in the shape of a near groove cut on a phonograph record at a pitch of from 1 to 2 mm.

### SUMMARY OF THE INVENTION

The invention is directed to a polarizing plate having a transparent protective film made of a cyclic olefin-based resin provided on at least one surface of a polyvinyl alcohol polarizer and it is an object of the invention to provide a method for fabricating a polarizing plate good in adhesive strength between the polarizer and the transparent protective film and having a uniform polarization characteristic.

It is another object of the invention to provide a polarizing plate obtained with the fabrication method. It is still another object of the invention to provide an optical film obtained by laminating polarizing plates and an image display such as LCD and ELD using the polarizing plate or the optical film.

The inventors have conducted serious studies in order to solve the tasks and as a result of the studies, found that the objects can be achieved with a fabrication method for a polarizing plate shown below, which have led to completion of the invention. The invention is as follows.

The invention is related to a fabrication method for a polarizing plate having a transparent protective film provided on at least one surface of a polarizer, wherein
the transparent protective film provided on the at least one surface comprises a cyclic olefin-based resin as a main component,
at least one resin layer and a polyvinyl alcohol-based adhesive layer are sequentially laminated on a surface of the transparent protective film that is adhered to the polarizer and
comprising a step of: adhering the polyvinyl alcohol-based adhesive layer on the transparent protective film and the polarizer in a condition of an aqueous liquid is present on an adhesion surface between the polyvinyl alcohol-based adhesive layer on the transparent protective film and the polarizer.

In the fabrication method for a polarizing plate, the aqueous liquid is preferably water.

In the fabrication method for a polarizing plate, the aqueous liquid is preferably an aqueous solution containing a crosslinking agent dissolved therein.

In the fabrication method for a polarizing plate, the crosslinking agent is preferably a melamine-based crosslinking agent.

In the fabrication method for a polarizing plate, the melamine-based crosslinking agent is preferably methylolmelamine.

In the fabrication method for a polarizing plate, the polarizer is preferably a polyvinyl alcohol type polarizer.

The invention is related to a polarizing plate obtained with a fabrication method above-mentioned.

The invention is related to an optical film comprising at least one polarizing plate above-mentioned.

The invention is related to an image display comprising the polarizing plate above-mentioned or the optical film above-mentioned.

In a fabrication method for a polarizing plate of the invention, a transparent protective film comprising a cyclic olefin-based resin as a main component and a polarizer are adhered. The transparent protective film is used in a state where a polyvinyl alcohol-based adhesive layer is laminated, in advance, on a surface thereof adhered to the polarizer with a resin layer interposed therebetween, and thereby, the polarizer and the transparent protective film can be adhered to each other in a good adhesion state.

In a process in which the polarizer and the transparent protective film are adhered, an aqueous liquid is present on an adhesion surface between the transparent protective film and the polarizer, that is, on the polyvinyl alcohol-based adhesive layer. With the process, there can be obtained a polarizing plate in which an appearance defect, especially a striation irregularity, is suppressed. Such a polarizing plate, since a striation appearance defect is suppressed therein, has a uniform polarization characteristic and can provide an image display such as LCD or ELD with a high performance. Such a fabrication method of the invention is suitable for continuous fabrication and can fabricate polarizing plates with good productivity.

A better adhesive strength is exerted with an aqueous solution containing a crosslinking agent as an aqueous liquid, thereby enabling a polarizing plate fewer in appearance defects to be obtained. As crosslinking agents, preferable are melamine-based crosslinking agents, among which especially preferable is methylolmelamine.

No detailed mechanism is still to be clarified of why a fabrication method of the invention is effective for suppressing a striation appearance defect occurring in a polarizing plate. It is imagined that in the conventional fabrication method, an adhesive solution with a high viscosity contacts a surface of a polarizer or a transparent protective film in a process in which the polarizer and the transparent protective film are adhered, which causes a kind of physical force to act in a way as a factor in generation of a striation appearance defect or defects, whereas in the invention, the physical factor could be eliminated due to the presence of an aqueous liquid.

### BRIEF DESCRIPTION OF THE DRAWINGS

FIG. 1 is an example of a schematic view of a polarizing plate of the invention in a fabrication method for the polarizing plate of the invention.

FIG. 2 is an example of a polarizing plate of the invention.

### DESCRIPTION OF THE PREFFERRED EMBODIMENTS

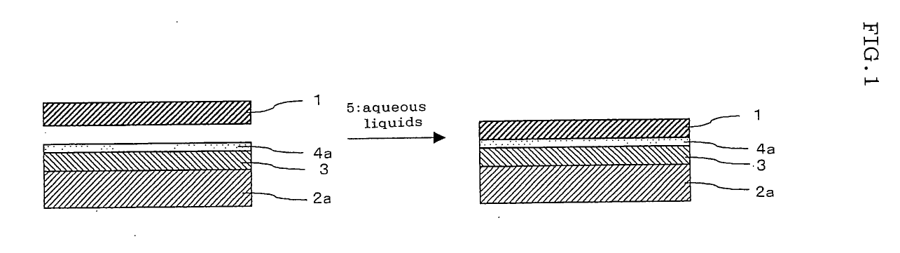

Description will be given of a fabrication method for a polarizing plate of the invention below with reference to the accompanying drawings. FIG. 1 is a schematic view of a method for fabricating a polarizing plate in which a resin layer (3) and a polyvinyl alcohol-based adhesive layer (4a) are sequentially laminated in the order on one surface of a transparent protective film (2a) comprising a cyclic olefin-based resin as a main component, which composite is adhered to one side of a polarizer (1) in the presence of an aqueous liquid (5) therebetween. In FIG. 1, the transparent protective film (2a) is provided only on the one side of the polarizer (1), while two transparent protective films (2a) can be provided on both sides in a similar way.

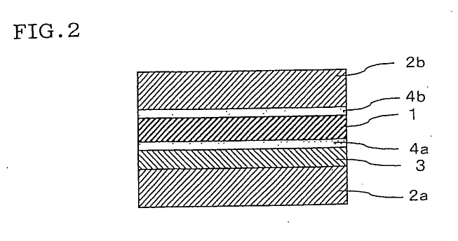

FIG. 2 is a sectional view of a polarizing plate obtained in FIG. 1 in which a transparent protective film (2b) is provided on polarizer (1) on a side of which no transparent protective film (2a) is provided, with a adhesive layer (4b) interposed therebetween. The transparent protective film (2b) can be not only a transparent protective film (2a) comprising a cyclic olefin-based resin as a main component, but also a film made of a material other than a material of the transparent protective film (2a). The adhesive layer (4b) can be a polyvinyl alcohol-based adhesive layer (4a), but also can be made of a material other than a material of the polyvinyl alcohol-based adhesive layer (4a). The adhesive layer (4b) can be provided with the resin layer (3) interposed between the layer and the transparent protective layer (2b). In a case where protective transparent films (2) are provided on both sides of the polarizer (1), the protective films (2) may also be simultaneously adhered on both sides or may also be sequentially adhered to respective sides.

While in FIGS. 1 and 2, there are shown cases where the resin layer (3) is of a single layer, the resin layer (3) may be of plural layers.

No specific limitation is imposed on a polarizer (1) and various kinds of polarizers can be employed as the polarizer (1). Examples thereof include: polarizers obtained in a procedure in which a dichroic material such as iodine or a dichroic dye is made to be adsorbed to a hydrophilic polymer film such as a polyvinyl alcohol-based film, a partially formalized polyvinyl alcohol-based film or an ethylene vinyl acetate copolymer-based partially saponified film and then, such a hydrophilic polymer film is uniaxially stretched; polyene-based aligned films such as films made of dehydrates of polyvinyl alcohols and dehydrochlorinated compounds of polyvinyl chloride; and the like. Among them, preferable is a polarizer made of a polyvinyl alcohol-based film to which iodine or a dichroic material such as a dichroic dye is adsorbed.

A polyvinyl alcohol-based film formed with any of methods including a flow expanding method in which an liquid obtained by dissolving a polyvinyl alcohol-based resin into water or an organic solvent is caused to flow over a surface to thereby form a film, a casting method, an extrusion molding method and the like, can be properly used. A degree of polymerization of a polyvinyl alcohol-based resin is preferably on the order in the range of from about 100 to about 5000 and more preferably in the range of from 1400 to 4000.

A polarizer to be obtained by dying a polyvinyl alcohol-based film with iodine or the like and uniaxially stretching the film can be fabricated, for example, with a method described below.

In a dying process, a polyvinyl alcohol-based film is immersed in a dye bath added with iodine thereinto at a temperature of the order in the range of from about 20 to about 70° C. for a time of the order in the range of from about 1 to about 20 min to cause iodine to be adsorbed to the film. A concentration of iodine in the dye bath is usually in the range of from about 0.1 to about 1 part by weight relative to 100 parts by weight of water. A dyeing auxiliary, which is an iodide such as potassium iodide, lithium iodide, sodium iodide, zinc iodide, aluminum iodide, lead iodide, copper iodide, barium iodide, calcium iodide, tin iodide or titanium iodide may be added usually at a proportion of the order in the range of from about 0.01 to about 20 parts by weight and preferably in the range of from 0.02 to 10 parts by weight relative to 100 parts by weight of water in a dye bath. The additives are especially preferable for enhancing a dyeing efficiency. A small quantity of an organic solvent compatible with water may be contained in addition to a water solvent.

A polyvinyl alcohol-based film may also be subjected to a swelling treatment in a water bath or the like for a time of the order in the range of from about 0.1 to about 10 min at a temperature of the order in the range of from about 20 to about 60° C. prior to a dyeing process in an aqueous solution containing iodine or a dichroic dye. Washing of a polyvinyl alcohol-based film with water can not only clean contamination and an anti-blocking agent on surfaces of the polyvinyl alcohol type film but also swell the polyvinyl alcohol-based film to thereby exert an effect of preventing dyeing ununiformity or unevenness from occurring.

A dye-treated polyvinyl alcohol-based film can be crosslinked when required. A composition of a crosslinking aqueous solution performing a crosslinking treatment is usually a proportion of the order of from about 1 to about 10 parts by weight of a crosslinking agent such as boric acid, borax, glyoxal or glutaraldehyde, alone or in a mixture, relative to 100 parts by weight of water. A concentration of a crosslinking agent is determined by taking a balance between an optical characteristic and shrinkage of a polarizing plate due to a stretching force occurring in the polyvinyl alcohol-based film into consideration.

A dyeing auxiliary, which is an iodide, such as potassium iodide, lithium iodide, sodium iodide, zinc iodide, aluminum iodide, lead iodide, copper iodide, barium iodide, calcium iodide, tin iodide or titanium iodide may be also added into a crosslinking bath at a concentration in the range of from about 0.05 to about 15 wt % and preferably at a concentration in the range of from 0.5 to 8 wt %. The additives are especially preferable in obtaining a uniform characteristic in a surface of a polarizer. A temperature of an aqueous solution is usually on the order in the range of from about 20 to about 70° C. and preferably in the range of from 40 to 60° C. A specific limitation is imposed on an immersion time and usually on the order in the range of from about 1 sec to about 15 min and preferably in the range of 5 sec to 10 min. A crosslinking bath may be added with a small quantity of an organic solvent compatible with water in addition to a water solvent.

A total stretching ratio of a polyvinyl alcohol-based film is on the order in the range of from about 3 to about 7 times and preferably in the range of from 5 to 7 times relative to the original length. If the total stretching ratio exceeds 7 times, the film is broken down with ease. Stretching may be conducted either after dyeing with iodine, or while being dyed or crosslinked, or before dyeing with iodine. No specific limitation is imposed on a method for stretching, the number of times of stretching, and stretching may be conducted only in one of the steps. Plural times of stretching may be conducted in the same step.

A polyvinyl alcohol-based film treated with iodine adsorption and alignment can have a step of immersing the film in an aqueous solution of an iodide such as potassium iodide at a concentration in the range of from about 0.1 to about 10 wt % at a temperature of the order in the range of from about 10 to about 60° C. and preferably at a temperature of the order in the range of 30 to 40° C. for a time in the range of about 1 sec to about 1 min. An auxiliary such as zinc sulfate or zinc chloride may be also added into an iodide aqueous solution. A polyvinyl alcohol-based film treated with iodine adsorption and alignment can have a step of washing with water and a step of drying at a temperature of the order in the range of from about 20 to about 80° C. for a time of the order in the range of about 1 min to about 10 min.

No specific limitation is imposed on a thickness of a polarizer (1), which is usually on the order in the range of from about 5 to about 80 μm. With a less thickness of a polarizer, water included in the polarizer is easier to evaporate in a drying step or the like in the course of adhesion thereof to a transparent protective film in a fabrication process for the polarizing plate. Therefore, an extensibility of a polarizer decreases to generate a conspicuous striation appearance defect with ease. Such a phenomenon is revealed remarkably in a polarizer having a thickness of especially 20 μm or less, whereas according to a fabrication method for a polarizing plate of the invention, generation of a striation appearance defect can be suppressed even in a case of a polarizer having a thickness of 20 μm or less.

A cyclic olefin-based resin that is a main component of a transparent protective film (2a) is a generic term, which is stated in, for example, JP-A Nos. 3-14882, 3-122137 and the like. Examples thereof, to be concrete, include: a ring opening polymer of a cyclic olefin; an addition polymer of a cyclic olefin; random copolymers of a cyclic olefin and an α-olefin such as ethylene or propylene; and graft modified products obtained by modification of the above exemplified polymers with an unsaturated carboxylic acid or a derivative thereof. In addition thereto, examples thereof include hydrogenated products of the above exemplified polymers. While a cyclic olefin is not specifically limited, examples thereof include norbornene, tetracyclododecene and derivatives thereof. Commercially available examples thereof include ZEONEX and ZEONOR manufactured by ZEON Corporation, ARTON manufactured by JSR Corporation and the like.

While in the invention, a transparent protective film (2a) on one side comprises a cyclic olefin-based resin as a main component, a transparent protective film (2b) on the other side can be made of a material other than a cyclic olefin-based resin, as a main component. Proper transparent materials may be used as a transparent polymer or a film material that forms the transparent protective film (2b), and the material having outstanding transparency, mechanical strength, heat stability and outstanding moisture interception property, etc. may be preferably used, besides cyclic olefin-based resins. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned. A transparent protective film can also be formed as a cured layer made of a thermally curing or ultraviolet curing type resin such as acrylic-based, urethane-based, acrylic urethane-based, epoxy-based and silicone-based resins.

Moreover, as is described in Japanese Patent Laid-Open Publication No.2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used. Since the films are less in retardation and less in photoelastic coefficient, faults such as unevenness due to a strain in a polarizing plate can be removed and besides, since they are less in moisture permeability, they are excellent in durability under humidified environment.

Moreover, it is preferable that the transparent protection film (2b) may have as little coloring as possible. Accordingly, a protection film having a retardation value in a film thickness direction represented by Rth=[(nx+ny)/2−nz]×d of from −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protection film may mostly be cancelled using a protection film having a retardation value (Rth) of from −90 nm to +75 nm in a thickness direction. The retardation value (Rth) in a thickness direction is preferably from −80 nm to +60 nm, and especially preferably from −70 nm to +45 nm.

Thickness values of transparent protective films (2a) and (2b) can be properly determined and generally on the order in the range of from about 1 to about 500 μm from the viewpoint of a strength, workability such as handlability, requirement for a thin film and the like. Especially, the thickness values are preferably is in the range of from 1 to 300 μm and more preferably in the range of from 5 to 200 μm. A thickness of a transparent protective film (2) is preferably 50 μm or less.

A hard coat layer may be prepared, or antireflection processing, processing aiming at sticking prevention, diffusion or anti glare may be performed onto the face on which the polarizing film of the above described transparent protective film (2a), (2b) has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective film (2a) (2b).

No specific limitation is imposed on a resin layer (3) and any of resin layers (3) can be employed as far as it adheres well to a transparent protective film (2a) comprising a cyclic olefin-based resin as a main component. Examples thereof that can be used include various resins such as ester-based, ether-based, carbonate-based, urethane-based and silicone-based resins. The resin layer (3) may be either of an aqueous type or a solvent type. Among them, preferable are an aqueous type urethane resin and a silicon-based resin. A titanium-based or a tin-based catalyst can be added to a resin, of which the resin layer is made, in order to cause a coupling agent such as a silane coupling agent or a titanium coupling agent to react with a good efficiency. With this, an adhesive strength between a polyvinyl alcohol polarizer (1) and a transparent protective film (2a) can be stronger. Another additive may also be added into the resin layer (3). Examples thereof that may be used, to be concrete, include a tackifier such as terpene resin, phenol resin, terpene-phenol resin, rosin resin and xylene resin; an ultra absorbent, an antioxidant and a stabilizer such as a heat resistance stabilizer.

The resin layer (3) is formed by coating and drying a solution diluted to a proper concentration in consideration of a thickness after drying and smoothness of coating according to a known technique. A thickness after drying of the resin layer (3) is preferably in the range of from about 0.01 to about 10 μm and more preferably in the range of from 0.1 to 2 μm. In a case where the resin layer (3) is constituted of plural layers, as well, the total thickness of the resin layer (3) is preferably in the above range.

Note that a resin layer (3) can be provided on a surface of a polarizer to which a transparent protective film (2b) is adhered and can apply an easy adhesion treatment thereon. Examples thereof include a dry treatment such as a plasma treatment, a corona treatment, a chemical treatment such as an alkali treatment and a coating treatment forming an easy adhesive layer.

No specific limitation is usually imposed on a polyvinyl alcohol-based adhesive used to adhere a transparent protective film to a polarizer in order to form a polyvinyl alcohol-based adhesive layer (4a).

Examples of polyvinyl alcohol-based resin include: a polyvinyl alcohol obtained by saponifying a polyvinyl acetate; a derivative thereof; a saponified copolymer of vinyl acetate and a monomer copolymerizable therewith; and polyvinyl alcohols modified by acetalization, urethanization, etherification, grafting, phosphate esterification and the like. Examples of the monomers include, unsaturated carboxylic acids such as maleic anhydride, fumaric acid, crotonic acid, itaconic acid and (meth)acrylic acid, and esters thereof; α-olefins such as ethylene and propylene; (meth)allylsulfonic acid or sodium salt thereof, (meth)allylsulfonate; sodium sulfonate (monoalkyl maleate), sodium disulfonate (alkyl maleate); N-methylolacrylamide; an alkai salt of acrylamide alkylsulfonate; N-vinylpyrrolidone, a derivative of N-vinylpyrrolidone and the like. The polyvinyl alcohol-based resins can be either used alone or in combination of two kinds or more.

While no specific limitation is imposed on a polyvinyl alcohol-based resin, an average degree of polymerization is usually on the order in the range of from about 100 to about 3000 and preferably in the range of from 500 to 3000 and a average degree of saponification is usually on the order in the range of from about 85 to about 100 mol % and preferably in the range of from 90 to 100 mol % in consideration of adherence.

As a polyvinyl alcohol-based resin, there can be used a polyvinyl alcohol resin having an acetoacetyl group. A polyvinyl alcohol resin having an acetoacetyl group is a polyvinyl alcohol-based adhesive having a highly reactive functional group with which a durability of a polarizing plate is preferably improved.

A polyvinyl alcohol-based resin containing an acetoacetyl group is obtained by reacting a polyvinyl alcohol-based resin and diketene to each other with a known method. Examples of known methods include: a method in which a polyvinyl alcohol-based resin is dispersed into a solvent such as acetic acid, to which diketene is added and a method in which a polyvinyl alcohol-based resin is previously dissolved into a solvent such as dimethylformamide or dioxane, to which diketene is added. Another example is a method in which diketene gas or diketene liquid is brought into direct contact with a polyvinyl alcohol.

No specific limitation is imposed on a degree of modification by an acetoacetyl group in a polyvinyl alcohol-based resin containing an acetoacetyl group or groups as far as the degree of modification is 0.1 mol % or more. If the degree of modification is less than 0.1 mol %, water resistance of an adhesive layer is insufficient, which is improper. A degree of modification by an acetoacetyl group is preferably in the range of about 0.1 to about 40 mol % and more preferably in the range of 1 to 20 mol %. If a degree of modification by an acetoacetyl group exceeds 40 mol %, reaction sites with a crosslinking agent is fewer to thereby reduce an effect of improvement on water resistance. A degree of modification by an acetoacetyl group is a value measured with NMR.

It was found that in a fabrication method of the invention, an adhesive with a higher reactivity has a more effect in suppression of a striation appearance defect than an adhesive with a lower reactivity. The mechanism working in the phenomenon cannot be said to be certain. The mechanism is thought for the time being in this way, since an adhesive with a lower reactivity is generally higher in solubility in water, an adhesive layer temporarily formed on a surface of a transparent protective film is again dissolved into an added aqueous liquid. A viscosity of the added aqueous solution increases in the vicinity of the surface of the polarizer to which the transparent protective film is adhered. Therefore, a fabrication method of the invention is especially effective for a case where a polyvinyl alcohol-based adhesive with a higher reactivity is used and, as a polyvinyl alcohol-based adhesive, a polyvinyl alcohol-based adhesive having an acetoacetyl group is good in adherence.

A polyvinyl alcohol-based adhesive containing a crosslinking agent can be used. Such an adhesive is especially effective in a case where water is used as an aqueous liquid (5). A crosslinking agent may or may not be contained in an adhesive in a case where an aqueous solution containing a crosslinking agent is used as an aqueous liquid (5).

Any of crosslinking agents that have been used in a polyvinyl alcohol-based adhesive can be used as a crosslinking agent in the invention without a specific limitation thereon. Description will be given of the crosslinking agent later. A mixing quantity of a crosslinking agent is usually on the order in the range of from about 0.1 to about 35 parts by weight and preferably in the range of from 10 to 25 parts by weight relative to 100 parts by weight of a polyvinyl alcohol-based resin. A polarizing plate can be obtained with a uniform polarizing characteristic and excellence in durability in the range of a mixing quantity of a crosslinking agent. On the other hand, in order to improve durability more, a crosslinking agent can be added to a polyvinyl alcohol-based resin at more than 30 parts by weight and 46 parts by weight or lower relative to 100 parts by weight of the polyvinyl alcohol-based resin. Especially, in a case where a polyvinyl alcohol-based resin containing an acetoacetyl group is used, it is preferable to use a crosslinking agent at a quantity more than 30 parts by weight. By adding a crosslinking agent in the range that is more than 30 parts by weight and 46 parts by weight or less, water resistance can be drastically improved. A more mixing quantity of a crosslinking agent is more preferable still within the range and preferable is 31 parts by weight or more, more preferable is 32 parts by weight and most preferable is 35 parts by weight or more. On the other hand, if a mixing quantity of a crosslinking agent is excessively more, a reaction of a crosslinking agent progresses in a short time to thereby tend to cause an adhesive to be gelated. As a result, a pot life as an adhesive is extremely shorter, which makes industrial use thereof difficult. A mixing quantity of a crosslinking agent is preferably 46 parts by weight or less, more preferably 45 parts by weight or less and most preferably 40 parts by weight or less from the view point described above.

Note that various additives described below can be further mixed into an adhesive: coupling agents such as a silane coupling agent and a titanium coupling agent; various kinds of tackifiers; an ultraviolet absorbent; an antioxidant; stabilizers such as a heat resistance stabilizer and a hydrolysis resistance stabilizer; and the like.

A polyvinyl alcohol adhesive layer (4a) can be formed by coating and drying a polyvinyl alcohol-based adhesive (an aqueous solution). A solvent such as ethanol can be appropriately mixed into an aqueous solution. While a concentration in an aqueous solution is properly adjusted in consideration of adherence, smoothness in coating and the like, the concentration is preferably in the range of from about 1 to about 20 wt %, for example. A coating method can be of a conventionally known technique.

A thickness of a polyvinyl alcohol adhesive layer (4a) is preferably 20 μm or less since an excessive thickness after drying is not preferable in regard to adherence between a polarizer (1) and a transparent protective film (2a). More preferable is in the range of from 0.01 to 10 μm and further more preferable is in the range of from 0.1 to 5 μm.

Note that a polyvinyl alcohol-based adhesive exemplified in connection with the adhesive layer (4a) can be used for a adhesive layer (4b) and besides, other adhesives can be used.

In a fabrication method for a polarizing plate of the invention, the polarizer (1) is adhered to the transparent protective film (2a) on which the adhesive layer (4a) is provided with the resin layer (3) therebetween using an aqueous liquid (5). An aqueous liquid may be present on any of the sides of the adhesive layer (4a) and the polarizer (1) and on both sides thereof.

Water, for example, is used as an aqueous liquid (5). An aqueous solution containing a crosslinking agent dissolved therein can be used as an aqueous liquid (5). A crosslinking agent that has been used in a polyvinyl alcohol-based adhesive can be used as a crosslinking agent without a specific limitation thereon.

A crosslinking agent that can be used is a compound having at least two functional groups having reactivity with a polyvinyl alcohol-based resin. Examples thereof include: alkylene diamines having an alkylene group and two amino groups such as ethylene diamine, triethylene diamine and hexamethylene diamine; isocyanates such as tolylene diisocyanate, hydrogenated tolylene diisocyanate, trimethylolpropane tolylene diisocyanate adduct, triphenylmethane triisocyanate, methylenebis(4-phenylmethane) triisocyanate and isophorone diisocyanate, and ketoxime-blocked products thereof or isocyanates of phenol-blocked products; epoxy compounds such as ethylene glycol diglycidyl ether, polyethylene glycol diglycidyl ether, glycerin di- or triglicydyl ether, 1,6-hexanediol diglycidyl ether, trimethylolpropane triglycidyl ether, diglicidyl aniline and diglycidyl amine; monoaldehydes such as formaldehyde, acetaldehyde, propionaldehyde and butylaldehyde; dialdehydes such as glyoxal, malonaldehyde, succindialdehyde, glutardialdehyde, maleic dialdehyde and phthaldialdehyde; amino-formaldehyde resins such as condensates with formaldehyde of methylolurea, methylolmelamine, alkylated methylolurea, alkylated methylolmelamine, acetoguanamine and benzoguanamine; salts of divalent metals or trivalent metals such as sodium, potassium, magnesium, calcium, aluminum, iron and nickel, and oxides of the metals. As a croislinking agent, preferable is a melamine-based crosslinking agent and especially preferable is methylolmelamine.

While no specific limitation is placed on a concentration of a crosslinking agent in an aqueous solution, the concentration is usually 20 wt % or less, preferably in the range of from 0.01 to 10 wt % and more preferably in the range of from 0.1 to 5 wt %.

A viscosity of an aqueous liquid is usually in the range of from 0.1 to 10 cP and preferably in the range of from 0.5 to 5 cP. A viscosity of the aqueous liquid is a value measured according to a method described in an example. If the viscosity is less than 0.1 cP, coating is in some case difficult, on the other hand, if exceeding 10 cP, an appearance defect arises with ease.

No specific limitation is imposed on supplying an aqueous liquid and any of aqueous liquids as far as a method is adopted in which it is present on an adhesion surface when the polarizer (1) is adhered to the adhesive layer (4a) provided on the transparent protective film (2a). There can be exemplified a method in which the aqueous liquid is supplied to the polarizer (1) and/or the adhesive layer (4a).

No specific limitation is placed on a supply method for an aqueous liquid (5) and examples of supply methods include a dropping method, a coating method, a spray method and the like. Examples of devices used for a supply method include a nozzle, a spray, a coater and the like, from a group consisting of which a kind is properly selected. An aqueous liquid is coated and thereafter, a drying step usually follows. A drying temperature is usually on the order in the range of 5 to 150° C. and preferably on the order in the range from about 30 to about 120° C. and a drying time is usually 120 sec or more and preferably 300 sec or more.

As an adhesion method, there is exemplified a method in which a set of the polarizer (1) and the transparent protective film (2a) on which the adhesive layer (4a) is provided are caused to continuously pass through between a pair of rolls so that the polarizer (1) and the adhesive layer (4a) on the transparent protective film (2a) on which an adhesive layer (4a) is provided are adhered. No specific limitation is placed on rolls and any pair of rolls can be used as far as the set of the polarizer (1) and the transparent protective film (2a) is adhered to each other under a roll pressure. For example, a pair of laminate nip rolls is used as the pair of rolls. No particular limitation is placed on a material of the rolls and any of rubber or metal may be used as a material thereof. In this case, while no specific limitation is imposed on the transportation speed of the transparent protective film (2a) and the polarizer (1). The speed is usually on the order in the range of from about 0.08 to about 0.5 m/s and preferably on the order in the range of from 0.11 to 0.34 m/s.

While a supply quantity of an aqueous liquid is properly adjusted by a transportation speed or the like, the supply quantity is usually on the order in the range of from about 0.5 to about 3.4 ml/s and preferably in the range of from 0.5 to 1.7 ml/s. A supply quantity of an aqueous liquid can be adjusted according to a width of a master film.

No specific limitation is imposed on a supply method for a aqueous liquid (5) and any of methods can be adopted as far as, in the method, the aqueous liquid (5) is present on an adhesion surface between an adhesive layer (4a) on a transparent protective film (2a) film and the polarizer(1) when both are adhered to each other. For example, an aqueous liquid (5) can be supplied onto the adhesion surface between an adhesive layer (4a) on a transparent protective film (2a) film and the polarizer (1). By supplying the aqueous liquid (5) onto the adhesion surface, the adhesive layer (4a) does not contact the aqueous liquid (5) just before the adhesion; therefore such a method is preferable in durability of an adhesive and because of difficulty in generation of a striation irregularity.

By supplying an aqueous liquid onto the adhesive layer (4a) on the transparent protective film (2a) or the polarizer (1) during transportation, the aqueous liquid can be guided onto the adhesion surface while both are transported.

In a step during which the adhesive layer (4a) on the transparent protective film (2a) and the polarizer (1) are (continuously) adhered to each other, the aqueous liquid (5) is preferably supplied onto the adhesion surface immediately before the adhesion. The term “immediately before the adhesion” means that both are adhered to each other within a time of the order of about 2 sec after supply of the aqueous liquid (5). The shorter this time is, the better it is and the adhesion is preferably conducted within 1 sec and more preferably within 0.5 sec after the aqueous liquid is supplied. In a case where the aqueous liquid (5) is supplied onto the adhesive layer (4a), the adhesive is dissolved more than required into the aqueous liquid (5) if a time spent till the adhesion exceeds 2 sec, which leads to a cause of irregularity with ease. Since a water percent is excessively large in a case where the aqueous liquid (5) is supplied onto the adhesive layer (4a) on the transparent protective film (2a) or onto the polarizer (1), irregularity is easy to occur after drying. In a case where the aqueous liquid (5) is supplied immediately before the adhesion, a method may be adopted in which a liquid sink is provided in an adhesion portion and the transparent protective film (2a) and the polarizer (1) pass over the liquid sink immediately before the adhesion.

Note that in a case where the aqueous liquid (5) is present in excess on the adhesion surface between the adhesive layer (4a) on the transparent protective film (2a) and the polarizer (1) and part of the aqueous liquid (5) is leaked from an edge portion of the adhesion surface, the excessive quantity is removed with a suction nozzle or the like or collected into the central portion of the adhesion surface by an air blow with an air nozzle or the like, thereby enabling contamination due to the leakage of aqueous liquid to be prevented.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyallylates and polyamides; aligned films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal biaxial stretching and a biaxial stretched film as inclined alignment film etc. may be used. As inclined alignment film, for example, a film obtained using a method in which a heat shrinking film is adhered to a polymer film, and then the combined film is heated and stretched or shrinked under a condition of being influenced by a shrinking force, or a film that is aligned in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy (D-BEF and others manufactured by 3M Co., Ltd.); an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported(PCF350 manufactured by NITTO DENKO CORPORATION, Transmax manufactured by Merck Co., Ltd., and others); etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned optical film has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic emitting layer and a metal electrode are laminated on a transparent substrate in an order configuring an illuminant (organic electro luminescence illuminant). Here, an organic emitting layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic emitting layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic emitting layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic emitting layer is formed by a very thin film about 10 nm in thickness. For this reason, light is transmitted nearly completely through organic emitting layer as through transparent electrode. Consequently, since the light that enters, when light is not emitted, as incident light from a surface of a transparent substrate and is transmitted through a transparent electrode and an organic emitting layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

Description will be given of a construction and an effect of the invention based on examples or the like. Note that in the examples or the like, part or parts and % are those by weight unless otherwise specified.

(Viscosity of Aqueous Liquid)

A viscosity at a rate of shear of 82000 (1/s) was measured in a condition of 23° C. using a viscosity measuring instrument (Rheometer Rheostress 1, manufactured by Thermo Haake Co.).

(Thickness Values of Adhesive Layer and Resin Layer)

The thickness values were measured in observation of a section with SEM.

(Polarizer 1)

A polyvinyl alcohol film having a thickness of 80 μm was dyed in an iodine aqueous solution at 5 wt % (a weight ratio of iodine/potassium iodide=1/10). The dyed polyvinyl alcohol film was then immersed in an aqueous solution containing 3 wt % of boric acid and 2 wt % of potassium iodide, further stretched to a ratio of 5.5 times in an aqueous solution containing 4 wt % of boric acid and 3 wt % of potassium iodide and thereafter, again immersed in a 5 wt % potassium iodide aqueous solution. Thereafter, the polyvinyl alcohol film was dried in an oven at 40° C. for 3 min to thereby obtain a polarizer having a thickness of 30 μm. The polarizer is hereinafter referred to polarizer 1.

(Polarizer 2)

A polarizer having a thickness of 31 μm was obtained in a similar way to that in fabrication of the polarizer 1 with the exception that in the fabrication of the polarizer 1, a drying time in the oven at 40° C. was 8 min. The polarizer is hereinafter referred to polarizer 2.

(Transparent Protective Film 1)

A corona treatment was applied to a cyclic olefin-based resin film having a thickness of 40 μm (Trade name: ZEONOR, manufactured by ZEON Corporation). A liquid obtained by mixing 1 part by weight of a silane coupling agent (Trade name: KBM603, manufactured by Shin-Etsu Chemical Co., Ltd.) to 10 parts by weight of a urethane-based resin (Trade name: SUPERFLEX 600, manufactured by DAI-ICHI KOGYO SEIYAKU CO., LTD.) sold on the market and stirring the mixture was coated on the corona treated surface. Thereafter, the wet coat was dried at 120° C. for 2 min to form a resin layer. A thickness after the drying of the resin layer was in the range of from 0.3 to 0.6 μm. Then, a solution obtained by dissolving 10 parts by weight of a polyvinyl alcohol into 90 parts by weight of a mixed liquid at a wt ratio of water/ethanol=60/40 was coated on the resin layer and the wet coat was dried at 120° C. for 2 min to form a polyvinyl alcohol-based adhesive layer having a thickness of about 0.6 μm. The polyvinyl alcohol-based adhesive layer is hereinafter referred to as transparent protective film 1.

(Transparent Protective Film 2)

A similar operation to that for the transparent protective film 1 was conducted with the exception that in fabrication of the transparent protective film 1, no resin layer was formed. Thus obtained film is hereinafter referred to as transparent protective film 2.

(Transparent Protective Film 3)

A saponified triacetylcellulose film having a thickness of 40 μm (Trade name: FUJITAC T-40UZ, manufactured by FUJI PHOTO FILM Co., Ltd.) was used.

(Transparent Protective Film 4)

A similar operation to that for the transparent protective film 1 was conducted with the exception that in fabrication of the transparent protective film 1, 10 parts by weight of acetoacetyl group-modified polyvinyl alcohol resin (degree of acetylation of 13%) was used instead of 10 parts by weight of polyvinyl alcohol. Thus obtained film is hereinafter referred to as transparent protective film 4.

(Transparent Protective Film 5)

A corona treatment was applied to a cyclic olefin-based resin film having a thickness of 40 μm (Trade name: ZEONOR, manufactured by ZEON Corporation). A liquid obtained by mixing 1 part by weight of a silane coupling agent (Trade name: KBM603), manufactured by Shin-Etsu Chemical Co., Ltd.) to 10 parts by weight of a urethane-based resin (Trade name: SUPERFLEX 600, manufactured by DAI-ICHI KOGYO SEIYAKU CO., LTD) sold on the market and stirring the mixture was coated on the corona treated surface. Thereafter, the wet coat was dried at 120° C. for 2 min to form a resin layer. A thickness after the drying of the resin layer was in the range of from 0.3 to 0.6 μm. Then, a solution obtained by adding 1 part by weight of a melamine-based crosslinking agent (Trade name: WATERSOL S 695, manufactured by DAINIPPON INK AND CHEMICALS INC.) into 100 parts by weight of a solution obtained by dissolving 10 parts by weight of a polyvinyl alcohol into 90 parts by weight of a mixed liquid at a wt ratio of water/ethanol=60/40 was coated on the resin layer and the wet coat was dried at 120° C. for 2 min to form a polyvinyl alcohol-based adhesive layer having a thickness of about 0.6 μm. The polyvinyl alcohol-based adhesive layer is hereinafter referred to as transparent protective film 5.

(Transparent Protective Film 6)

A similar operation to that for the transparent protective film 5 was conducted with the exception that in fabrication of the transparent protective film 5, 10 parts by weight of acetoacetyl group-modified polyvinyl alcohol resin (degree of acetylation of 13%) was used instead of 10 parts by weight of polyvinyl alcohol. Thus obtained film is hereinafter referred to as transparent protective film 6.

(PVA-Based Adhesive 1)

An adhesive aqueous solution was fabricated by adjusting an aqueous solution containing 20 parts by weight of methylolmelamine relative to 100 parts by weight of an acetoacetyl group-modified polyvinyl alcohol resin (a degree of acetylation of 13%) so as to be at a concentration of 0.5%. Note that a thickness of an adhesive layer formed with a PVA-based adhesive 1 in each of the examples was set to 31 nm.

(Aqueous Liquid: Melamine-Based Crosslinking Agent Aqueous Solution)

An aqueous liquid was prepared by dissolving 0.97 parts by weight of methylolmelamine as a crosslinking agent into 49.03 parts by weight of water. A viscosity of the aqueous liquid was 3 cP.

### Example 1

To one side of a polarizer 1, a polyvinyl alcohol-based adhesive layer on a transparent protective film 1 on which water was coated so as to only wet the surface was adhered, while to the other side of the polarizer 1, a transparent protective film 3 on which a PVA-based adhesive 1 has been coated was adhered, which composite was dried at 60° C. for 10 min to thereby obtain a polarizing plate.

### Example 2

To one side of a polarizer 1, a polyvinyl alcohol-based adhesive layer on a transparent protective film 1 on which a melamine-based crosslinking aqueous solution was coated so as to only wet the surface was adhered, while to the other side of the polarizer 1, a transparent protective film 3 was adhered in a similar way to that in Example 1, which composite was dried at 60° C. for 10 min to thereby obtain a polarizing plate.

### Example 3

A polyvinyl alcohol-based adhesive layer on a transparent protective film 1 on which a melamine-based crosslinking aqueous solution was coated was adhered to each of both sides of a polarizer 2 and thereafter, the composite was dried at 40° C. for 72 hr to thereby obtain a polarizing plate.

### Example 4

A polarizing plate was obtained in a similar way to that in Example 1 with the exception that a transparent protective film 4 was used instead of a transparent protective film 1 in Example 1.

### Example 5

A polarizing plate was obtained in a similar way to that in Example 1 with the exception that a transparent protective film 5 was used instead of a transparent protective film 1 in Example 1.

### Example 6

A polarizing plate was obtained in a similar way to that in Example 1 with the exception that a transparent protective film 6 was used instead of a transparent protective film 1 in Example 1.

### Example 7

To one side of a polarizer 1, a polyvinyl alcohol-based adhesive layer on a transparent protective film 4 on which a melamine-based crosslinking aqueous solution was coated so as to only wet the surface was adhered, while to the other side of the polarizer 1, a transparent protective film 3 was adhered in a similar way to that in Example 1, which composite was dried at 60° C. for 10 min to thereby obtain a polarizing plate.

### Comparative Example 1

To one side of a polarizer 1, a polyvinyl alcohol-based adhesive layer on a transparent protective film 1 on which a PVA-based adhesive 1 was coated was adhered, while to the other side of the polarizer 1, a transparent protective film 3 was adhered in a similar way to that in Example 1, which composite was dried at 60° C. for 10 min to thereby obtain a polarizing plate.

### Comparative Example 2

To one side of a polarizer 1, a polyvinyl alcohol-based adhesive layer on a transparent protective film 2 on which water was coated so as to only wet the surface was adhered, while to the other side of the polarizer 1, a transparent protective film 3 was adhered in a similar way to that in Example 1, which composite was dried at 60° C. for 10 min to thereby obtain a polarizing plate.

### Comparative Example 3

To one side of a polarizer 1, a polyvinyl alcohol-based adhesive layer on a transparent protective film 2 on which a melamine-based crosslinking agent aqueous solution was coated so as to only wet the surface was adhered, while to the other side of the polarizer 1, a transparent protective film 3 was adhered in a similar way to that in Example 1, which composite was dried at 60° C. for 10 min to thereby obtain a polarizing plate.

### Comparative Example 4

To one side of a polarizer 1, a polyvinyl alcohol-based adhesive layer on a transparent protective film 2 on which a PVA-based adhesive 1 was coated was adhered, while to the other side of the polarizer 1, a transparent protective film 3 was adhered in a similar way to that in Example 1, which composite was dried at 60° C. for 10 min to thereby obtain a polarizing plate.

(Evaluation)

The following evaluations were conducted on each of the polarizing plates obtained in the examples and the comparative examples. Evaluations were conducted to polarizer 1 or 2 and one side transparent protective film 1 or 2. The results of the evaluations are shown in FIG. 1.

(Adhesion State)

In order to evaluate adherence, a test was conducted in which a polarizer and a transparent protective film are separated by a hand at ordinary temperature (23° C.). After a hot water immersion test (60° C.×3 hr) was conducted on a polarizing plate, a test was again conducted in which a polarizer and a transparent protective film are separated by a hand. Evaluation criteria and corresponding symbols were as follows:
OO: no separation occurs in any case of the ordinary temperature separation test and the hot water immersion test,
O: in the ordinary temperature separation test, no separation occurs, while in the hot water immersion test, separation occurs and
X: separation occurs in any case of the ordinary temperature separation test and the hot water immersion test.
   (Appearance)

Appearance when a polarizer and a transparent protective film were adhered to each other was also evaluated at the same time as a test for adhesion test. An evaluation method was applied on a polarizing plate having an area of 1 m². Evaluation criteria and corresponding symbols were as follows:
O: neither a rise nor a striation is visually observed.

X: a rise and a striation are visually observed, wherein the term “rise” means a state where a polarizer and a transparent protective film are not in close contact with each other and the term a “striation” means that a transparent protective film or a polarizer adheres between two parts of itself, though in a small area.

TABLE 1

| | | | | | | Adhesion | |
|---|---|---|---|---|---|---|---|
| | Polarizing plates | | | | | states | |
| | One sides (1) | | | Other sides (2) | | between | |
| | Transparent | Aqueous | | Aqueous | | polarizer | |
| | protective | liquids or | Kinds of | liquids or | Transparent | and one | |
| | films | adhesive | polarizers | adhesive | protective films | side (1) | appearance |
| Example 1 | Transparent | Water | Polarizer 1 | PVA-based | Transparent | ◯ | ◯ |
| | protective | | | adhesive 1 | protective film 3 | | |
| | film 1 | | | | | | |
| Example 2 | Transparent | Melamine-based | Polarizer 2 | PVA-based | Transparent | ◯◯ | ◯ |
| | protective | crosslinking | | adhesive 1 | protective film 3 | | |
| | film 1 | agent aqueous | | | | | |
| | | solution | | | | | |
| Example 3 | Transparent | Melamine-based | Polarizer 1 | Melamine-based | Transparent | ◯◯ | ◯ |
| | protective | crosslinking | | crosslinking | protective film 1 | | |
| | film 1 | agent aqueous | | agent aqueous | | | |
| | | solution | | solution | | | |
| Example 4 | Transparent | Water | Polarizer 1 | PVA-based | Transparent | ◯ | ◯ |
| | protective | | | adhesive 1 | protective film 3 | | |
| | film 4 | | | | | | |
| Example 5 | Transparent | Water | Polarizer 1 | PVA-based | Transparent | ◯ | ◯◯ |
| | protective | | | adhesive 1 | protective film 3 | | |
| | film 5 | | | | | | |
| Example 6 | Transparent | Water | Polarizer 1 | PVA-based | Transparent | ◯ | ◯◯ |
| | protective | | | adhesive 1 | protective film 3 | | |
| | film 6 | | | | | | |
| Example 7 | Transparent | Melamine-based | Polarizer 1 | PVA-based | Transparent | ◯◯ | ◯◯ |
| | protective | crosslinking | | adhesive 1 | protective film 3 | | |
| | film 4 | agent aqueous | | | | | |
| | | solution | | | | | |
| Comparative | Transparent | PVA-based | Polarizer 1 | PVA-based | Transparent | ◯ | X |
| Example 1 | protective | adhesive 1 | | adhesive 1 | protective film 3 | | |
| | film 1 | | | | | | |
| Comparative | Transparent | Water | Polarizer 1 | PVA-based | Transparent | X | ◯ |
| Example 2 | protective | | | adhesive 1 | protective film 3 | | |
| | film 2 | | | | | | |
| Comparative | Transparent | Melamine-based | Polarizer 1 | PVA-based | Transparent | X | ◯ |
| Example 3 | protective | crosslinking | | adhesive 1 | protective film 3 | | |
| | film 2 | agent aqueous | | | | | |
| | | solution | | | | | |
| Comparative | Transparent | PVA-based | Polarizer 1 | PVA-based | Transparent | X | X |
| Example 4 | protective | adhesive 1 | | adhesive 1 | protective film 3 | | |
| | film 2 | | | | | | |

It is understood from Table 1 that polarizing plates obtained according to the examples are better both in adhesive strength between a polarizer and a transparent protective film and in appearance can be fabricated in higher productivity, as compared with the comparative examples.

1. A fabrication method for a polarizing plate having a transparent protective film provided on at least one surface of a polarizer, wherein
the transparent protective film provided on the at least one surface comprises a cyclic olefin-based resin as a main component,
at least one resin layer and a polyvinyl alcohol-based adhesive layer are sequentially laminated on a surface of the transparent protective film that is adhered to the polarizer and
comprising a step of: adhering the polyvinyl alcohol-based adhesive layer on the transparent protective film and the polarizer in a condition of an aqueous liquid is present on an adhesion surface between the polyvinyl alcohol-based adhesive layer on the transparent protective film and the polarizer.

2. The fabrication method for a polarizing plate according to claim 1, wherein the aqueous liquid is water.

3. The fabrication method for a polarizing plate according to claim 1, wherein the aqueous liquid is an aqueous solution containing a crosslinking agent dissolved therein.

4. The fabrication method for a polarizing plate according to claim 3, wherein the crosslinking agent is a melamine-based crosslinking agent.

5. The fabrication method for a polarizing plate according to claim 4, wherein the melamine-based crosslinking agent is methylolmelamine.

6. The fabrication method for a polarizing plate according to any claim 1, wherein the polarizer is a polyvinyl alcohol type polarizer.

7. A polarizing plate obtained with a fabrication method according to claim 1.

8. An optical film comprising at least one polarizing plate according to claim 7.

9. An image display comprising the polarizing plate according to claim 7.

10. An image display comprising the optical film according to claim 8.
